(19) United States
(12) Patent Application Publication
(10) Pub. No.: US 2025/0046066 A1
(43) Pub. Date: Feb. 6, 2025

(54) APPARATUS AND METHOD FOR GENERATING TRAINING DATA

(71) Applicants: Hyundai Motor Company, Seoul (KR); Kia Corporation, Seoul (KR)

(72) Inventors: Hyun Kook PARK, Seoul (KR); Jae Hyeon PARK, Seoul (KR); Jae Hoon Cho, Seoul (KR)

(73) Assignees: Hyundai Motor Company, Seoul (KR); Kia Corporation, Seoul (KR)

(21) Appl. No.: 18/512,803

(22) Filed: Nov. 17, 2023

(30) Foreign Application Priority Data
Aug. 1, 2023 (KR) 10-2023-0100618

(51) Int. Cl. G06V 10/774; G06V 10/776; G06V 20/70

(52) U.S. Cl. CPC G06V 10/774; G06V 10/776; G06V 20/70; G06V 10/82

(57) ABSTRACT

An apparatus for generating training data includes a communication device that receives a daytime road image, a memory storing training data generation model for generating a night composite image from the daytime road image, and a processor that degrades strength of the daytime road image based on that the daytime road image is input as an input value to the training data generation model and reflects a night feature to generate the night composite image.

### CROSS-REFERENCE TO RELATED APPLICATION

The present application claims priority to Korean Patent Application No. 10-2023-0100618, filed on Aug. 1, 2023, the entire contents of which is incorporated herein for all purposes by this reference.

### BACKGROUND OF THE PRESENT DISCLOSURE

### Field of the Present Disclosure

The present disclosure relates to an apparatus and a method for generating training data, and more particularly, relates to a method for generating a dataset necessary to train a deep learning model.

### Description of Related Art

Recently, with the development of deep neural network-based computer vision technology in an autonomous driving technology, various artificial intelligence models, such as object detection, semantic segmentation, depth estimation, and lane detection, have been studied. Such an artificial intelligence model may perform supervised learning for large datasets constructed by obtaining a road image and performing labeling for matching the obtained image to a goal of each model, thus obtaining successful performance improvement.

In this regard, a dataset for training the artificial intelligence model is constructed with respect to autonomous driving in a daytime environment by an artificial intelligence-based autonomous driving technology which is currently being studied. However, because there is a need to apply the autonomous driving technology in a night environment as well as a daytime environment, there is a need to construct a dataset including a night road image.

A lot of cost and time is consumed in a process of obtaining a road image including various road traffic situations like constructing a daytime dataset in the present process, generating a label suitable for several artificial intelligence models, and constructing a good-quality training dataset.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus and a method for generating training data to reflect a feature of a night road image using training of a generative adversarial network (GAN) using a histogram vector in a daytime road dataset including a label.

Another aspect of the present disclosure provides an apparatus and a method for generating training data to obtain a road image in a daytime environment including various road traffic situations and construct a night training dataset by use of a label generated in the road image in the daytime road image without change.

The technical problems to be solved by the present disclosure are not limited to the aforementioned technical problems, and any other technical problems not mentioned herein will be clearly understood from the following description by those skilled in the art to which the present disclosure pertains.

According to an aspect of the present disclosure, an apparatus for generating training data may include a communication device that receives a daytime road image, a memory storing a training data generation model for generating a night composite image from the daytime road image, and a processor that degrades strength of the daytime road image based on that the daytime road image is input as an input value to the training data generation model and reflects a night feature to generate the night composite image.

The training data generation model may include a generator that degrades the strength of the daytime road image and reflects the night feature to generate the night composite image and a discriminator that learns a difference between the night composite image and a night reference image to discriminate the night composite image.

The generator may include a first generator that degrades the strength of the daytime road image and a second generator that reflects the night feature in the daytime road image.

The first generator may convert the daytime road image into a grayscale image and extracts a histogram vector from the grayscale image, may extract a strength degradation parameter from the histogram vector, and may reflect the strength degradation parameter in the daytime road image to degrade the strength of the daytime road image.

The processor may input the daytime road image to the first generator to degrade the strength and may input the daytime road image, the strength of which is degraded, to the second generator to generate the night composite image.

The processor may input the daytime road image to the second generator to reflect the night feature and may input the daytime road image in which the night feature is reflected to the first generator to generate the night composite image.

The processor may input the daytime road image to the first generator and the second generator at the same time to generate the night composite image.

The processor may transform the daytime road image so that the generator reduces an error between the night composite image and the night reference image, to generate the night composite image, upon concluding that the error is greater than a predetermined reference value.

The processor is configured to determine the night composite image as training data, upon concluding that an error between the night composite image and the night reference image is less than or equal to a predetermined reference value.

The processor may reflect label information included in the daytime road image in the night composite image to generate the training data.

According to another aspect of the present disclosure, a method for generating training data may include receiving a daytime road image, degrading strength of the daytime road image, based on that the daytime road image is input as an input value to a training data generation model for generating the daytime road image as a night composite image, and reflecting a night feature to generate the night composite image.

The training data generation model may include a generator that degrades the strength of the daytime road image and reflects the night feature to generate the night composite image and a discriminator that learns a difference between the night composite image and a night reference image to discriminate the night composite image.

The generator may include a first generator that degrades the strength of the daytime road image and a second generator that reflects the night feature in the daytime road image.

The degrading of the strength of the daytime road image may include converting the daytime road image into a grayscale image, extracting a histogram vector from the grayscale image, extracting a strength degradation parameter from the histogram vector, and reflecting the strength degradation parameter in the daytime road image to degrade the strength of the daytime road image.

The method may further include inputting the daytime road image to the first generator to degrade the strength and inputting the daytime road image, the strength of which is degraded, to the second generator to generate the night composite image.

The method may further include inputting the daytime road image to the second generator to reflect the night feature and inputting the daytime road image in which the night feature is reflected to the first generator to generate the night composite image.

The method may further include inputting the daytime road image to the first generator and the second generator at the same time to generate the night composite image.

The method may further include transforming the daytime road image so that the generator reduces an error between the night composite image and the night reference image, to generate the night composite image, based on that the error is greater than a predetermined reference value.

The method may further include determining the night composite image as training data, based on that an error between the night composite image and the night reference image is less than or equal to a predetermined reference value.

The determining of the training data may include reflecting label information included in the daytime road image in the night composite image to generate the training data.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a drawing illustrating a control block diagram of an apparatus for generating training data according to an exemplary embodiment of the present disclosure;

FIG. 2 is a drawing illustrating a schematic block diagram in which training data is generated and used by an apparatus for generating training data according to an exemplary embodiment of the present disclosure;

FIG. 3 is a drawing illustrating a detailed block diagram of a training data generation model according to an exemplary embodiment of the present disclosure;

FIG. 4 is a drawing illustrating a detailed structure of a generator and a discriminator in a training data generation model according to an exemplary embodiment of the present disclosure;

FIG. 5 is a drawing illustrating that a night road image is generated from a daytime road image by a training data generation model according to an exemplary embodiment of the present disclosure;

FIG. 6 is a drawing illustrating that a generator of an apparatus for generating training data degrades strength of a daytime road image according to an exemplary embodiment of the present disclosure;

FIG. 7 is a drawing illustrating an example of an order in which a generator and a discriminator are arranged in a training data generation model according to an exemplary embodiment of the present disclosure;

FIG. 8 is a drawing illustrating another example of an order in which a generator and a discriminator are arranged in a training data generation model according to an exemplary embodiment of the present disclosure;

FIG. 9 is a drawing illustrating another example of an order in which a generator and a discriminator are arranged in a training data generation model according to an exemplary embodiment of the present disclosure;

FIG. 10 is a drawing illustrating a control flowchart of a method for generating training data according to an exemplary embodiment of the present disclosure; and

FIG. 11 is a drawing illustrating a control flowchart of a method for generating training data, which is subsequent to FIG. 10, according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

It should be appreciated that various embodiments of the present disclosure and the terms used therein are not intended to limit the technological features set forth herein to various exemplary embodiments and include various changes, equivalents, or replacements for a corresponding embodiment.

With regard to the description of the drawings, similar reference numerals may be used to refer to similar or related elements.

A singular form of a noun corresponding to an item may include one item or a plurality of items, unless the relevant context clearly indicates otherwise.

As used herein, each of the expressions “A or B,” “at least one of A and B,” “at least one of A or B,” “A, B, or C,” “at least one of A, B, and C,” and “at least one of A, B, or C,” may include any and all combinations of one or more of the items listed together with a corresponding expression among the expressions.

Such terms as “1st” and “2nd,” or “first” and “second” may be used to simply distinguish a corresponding component from another, and does not limit the components in other aspect (e.g., importance or order).

It is to be understood that if any (e.g., a first) component is referred to, with or without the term “operatively” or “communicatively”, as “coupled with,” “coupled to,” “connected with,” or “connected to” another (e.g., a second) component, it means that the element may be coupled with the other element directly (e.g., wiredly), wirelessly, or via a third component.

The terms “comprises”, “includes”, etc. specify the presence of stated features, numbers, steps, operations, components, parts, or a combination thereof, but do not preclude the presence or addition of one or more other features, numbers, steps, operations, components, parts, or a combination thereof.

When one component is “connected,” “coupled,” “supported”, or “touched” to another component, this includes the case in which the components are directly connected, coupled, supported, or touched to each other as well as the case in which the components are indirectly connected, coupled, supported, or touched to each other through a third component.

When one component is located “on” another component, this includes the case in which another component is present between the two components as well as the case in which the one component is adjacent to the other component.

The term “and/or” includes a combination of a plurality of related described components or any of the plurality of related described components.

Hereinafter, a description will be provided of an operation principle and an exemplary embodiment of the present disclosure with reference to the accompanying drawings.

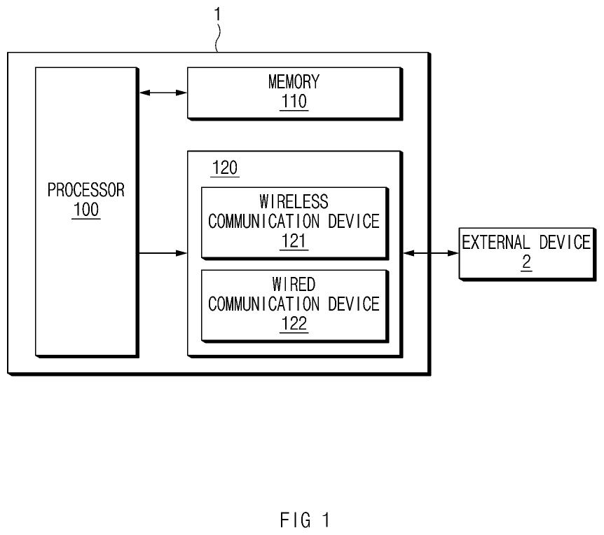

FIG. 1 is a drawing illustrating an apparatus for generating training data according to an exemplary embodiment of the present disclosure.

Referring to FIG. 1, an apparatus 1 for generating training data according to various exemplary embodiments of the present disclosure may include at least one processor 100, a memory 110, and a communication device 120 and may communicate with an external device 2 through the communication device 120 to generate training data 400.

The external device 2 in an exemplary embodiment of the present disclosure may refer to a device configured for obtaining a daytime road image 200 and may include, for example, a camera provided in a vehicle or a server device. When the external device 2 is the camera provided in the vehicle, it may capture a road image in the daytime to obtain the daytime road image 200 and transmit the daytime road image 200 to the apparatus 1 for generating the training data through the communication device 120. When the external device 2 is the server device, it may transmit the daytime road image 200 which is already captured to the apparatus 1 for generating the training data through the communication device 120. Accordingly, when the external device 2 is the device configured for transmitting the daytime road image 200 to the apparatus 1 for generating the training data, there is no limit to a configuration thereof.

The apparatus 1 for generating the training data according to various exemplary embodiments of the present disclosure may refer to all electronic devices, each of which includes the processor 100 and the memory 110, and may include, for example, a server device, a personal computer, a terminal, a portable telephone, a smartphone, a handheld device, and a wearable device. The above-mentioned electronic devices may be loaded into the vehicle to operate. Hereinafter, a description will be provided in detail of each component of the apparatus 1 for generating the training data.

The memory 110 may store various pieces of information necessary for driving of the apparatus 1 for generating the training data. In detail, the memory 110 may store an operating system and a program necessary of driving of the apparatus 1 for generating the training data or may store data necessary for driving of the apparatus 1 for generating the training data.

For example, the memory 110 may store a generative adversarial network (GAN) algorithm including generators 310 and 320 for generating the training data 400 and a discriminator 330. The memory 110 may store a parameter used for the GAN algorithm and a loss function.

The memory 110 may include a volatile memory 110, such as a state random access memory (SRAM) or a dynamic random access memory (DRAM), for temporarily storing data. Furthermore, the memory 110 may include a non-volatile memory 110, such as a read only memory (ROM), an erasable programmable ROM (EPROM), an electrically erasable programmable ROM (EEPROM), for storing data for a long time.

The communication device 120 may include a wired communication device 122 and a wireless communication device 121 to communicate with the external device 2.

The wired communication device 122 may access a wired communication network and may communicate with the external device 2 over the wired communication network. For example, the wired communication device 122 may access the wired communication network through an Ethernet (IEEE 802.3 technical standard) or may access the wired communication network through Controller Area Network (CAN) communication and may transmit and receive data with the external devices 2 over the wired communication network.

The wireless communication device 121 may include at least one of a short-range communication module and a long-range communication module.

The short-range communication module may communicate with the external device 2 adjacent to the apparatus 1 for generating the training data using a short-range communication method. Herein, the short-range communication module may use one of Bluetooth, Bluetooth low energy, Infrared data association (IrDA), ZigBee, wireless-fidelity (Wi-Fi), Wi-Fi Direct, ultra wideband (UWB), or Near to Field Communication (NFC).

The long-range communication module may include a communication module for performing various types of long-range communication and may include a mobile communication device 120. The mobile communication device 120 may transmit and receive a wireless signal with at least one of a base station, an external terminal, or the external device 2 on a mobile communication network. Furthermore, the long-range communication module may communicate with the external device 2 or the external device 2 such as another electronic device through a surrounding access point (AP). The AP may connect a local area network (LAN) connected with the apparatus 1 for generating the training data with a wide area network (WAN) connected with a communication server. Thus, the apparatus 1 for generating the training data may be connected with the communication server over the WAN to communicate with the communication server.

The processor 100 may output a control signal to overall control the apparatus 1 for generating the training data. The processor 100 may include one central processing unit (CPU) or a plurality of CPUs and a graphics processing unit (GPU) At the instant time, the processor 100 may be implemented as an array of a plurality of logic gates and may be implemented as a combination of the universal microprocessor 100 and the memory 110 which stores a program executable by the microprocessor 100.

The processor 100 may transform the daytime road image 200 received to generate the training data 400 for machine learning into a night composite image 325 to generate the training data 400. In detail, the processor 100 may degrade strength of the daytime road image 200 based on that the daytime road image 200 is input as an input value to the training data generation model 300 and may reflect a night feature to generate the night composite image 325.

Furthermore, the processor 100 may convert the daytime road image 200 into a grayscale image and may extract a histogram vector from the grayscale image. The processor 100 may extract a strength degradation parameter from the histogram vector and may reflect the strength degradation parameter in the daytime road image 200 to degrade the strength of the daytime road image 200.

Furthermore, according to an exemplary embodiment of the present disclosure, the processor 100 may input the daytime road image 200 to the first generator 310 to degrade the strength and may input the daytime road image 200, the strength of which is degraded, to the second generator 320 to generate the night composite image 325. According to another exemplary embodiment of the present disclosure, the processor 100 may input the daytime road image 200 to the second generator 320 to reflect a night feature and may input the daytime road image 200, the night feature of which is reflected, to the first generator 310 to generate the night composite image 325. According to another exemplary embodiment of the present disclosure, the processor 100 may input the daytime road image 200 to the first generator 310 and the second generator 320 at the same time to generate the night composite image 325.

Furthermore, the processor 100 may transform the daytime road image 200 so that the generators 310 and 320 reduce an error between the night composite image 325 and a night reference image 210, to generate the night composite image 325, based on that the error is greater than a predetermined reference value.

Furthermore, the processor 100 may be configured to determine the night composite image 325 as the training data 400, based on that the error between the night composite image 325 and the night reference image 210 is less than or equal to the predetermined reference value.

Thus, the apparatus 1 for generating the training data according to various exemplary embodiments of the present disclosure may receive the daytime road image 200 to generate a virtual night road image and may use the virtual night road image as the training data 400 of an artificial intelligence model for autonomous driving, thus reducing a time and effort required to collect a night road image independently of the daytime road image 200.

Hereinafter, a description will be provided of a detailed process in which the training data 400 is generated by the training data generation model 300 included in the apparatus 1 for generating the training data.

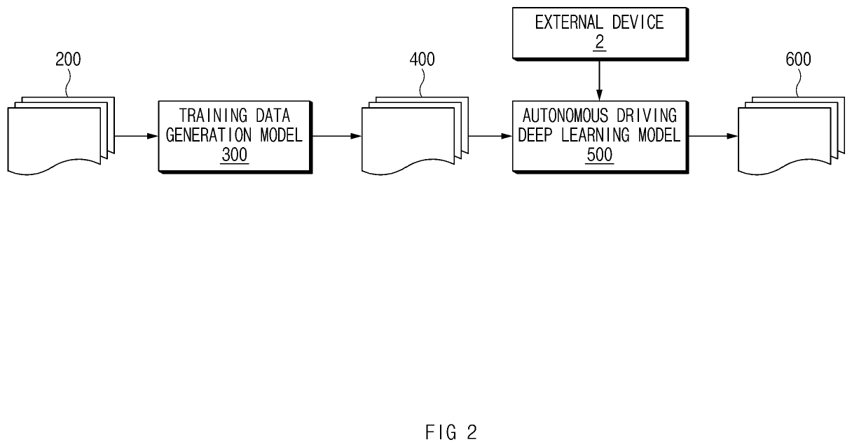

FIG. 2 is a drawing illustrating a schematic block diagram in which training data is generated and used by an apparatus for generating training data according to an exemplary embodiment of the present disclosure.

Referring to FIG. 2, an apparatus 1 for generating training data may obtain a daytime road image 200 from the outside and may input the daytime road image 200 to a training data generation model 300. As described above, the training data generation model 300 may include the GAN model including the plurality of generators 310 and 320. The daytime road image 200 is input as an input value to the training data generation model 300, and a night composite image 325 may be output as an output value. At the instant time, the training data generation model 300 may include a correlation for degrading strength of the daytime road image 200 which is the input value and reflecting a night feature to generate the night composite image 325 which is the output value.

Thus, the night composite image 325 generated by the training data generation model 300 may be used as training data 400 for training an autonomous driving deep learning model 500.

The autonomous driving deep learning model 500 shown in FIG. 2 may refer to an artificial neural network which is loaded into a vehicle or is stored in an external server to recognize a surrounding environment of the vehicle and generate vehicle control data 600 for autonomous driving.

The autonomous driving deep learning model 500 may train the artificial neural network by use of the training data 400 generated from the apparatus 1 for generating the training data as train data of the artificial neural network.

An example of a learning algorithm may be, but is not limited to, supervised learning, unsupervised learning, semi-supervised learning, or reinforcement learning.

The artificial neural network may include a plurality of neural network layers. Each of the neural network layers may include a plurality of weight values and may perform neural network operation by the result of operation of a previous layer and operation among the plurality of weights. The plurality of weight values of the plurality of neural network layers may be optimized by the result of training the artificial intelligence model. For example, the plurality of weight values may be updated so that a loss value or a cost value obtained by the artificial intelligence model during the training process is reduced or minimized.

The artificial neural network may include a deep neural network (DNN). For example, the artificial neural network may include, but is not limited to, a convolutional neural network (CNN), a deep neural network (DNN), a recurrent neural network (RNN), a restricted Boltzmann machine (RMB), a deep belief network (DBN), a bidirectional recurrent deep neural network (BRDNN), deep Q-networks, or the like.

The autonomous driving deep learning model 500 may receive the daytime road image 200 and a night road image from an external device 2, such as a camera, and may analyze the daytime road image 200 and the night road image by the artificial neural network to generate vehicle data for autonomous driving.

The apparatus 1 for generating the training data according to various exemplary embodiments of the present disclosure may aim to generate a night road image based on the GAN model, rather than collecting a night road image to be used as train data of the autonomous driving deep learning model 500 to train the autonomous driving deep learning model 500 to generate the vehicle control data 600. At the instant time, the apparatus 1 for generating the training data may use a label of the daytime road image 200 without change to reduce a time and cost for collecting the night road image.

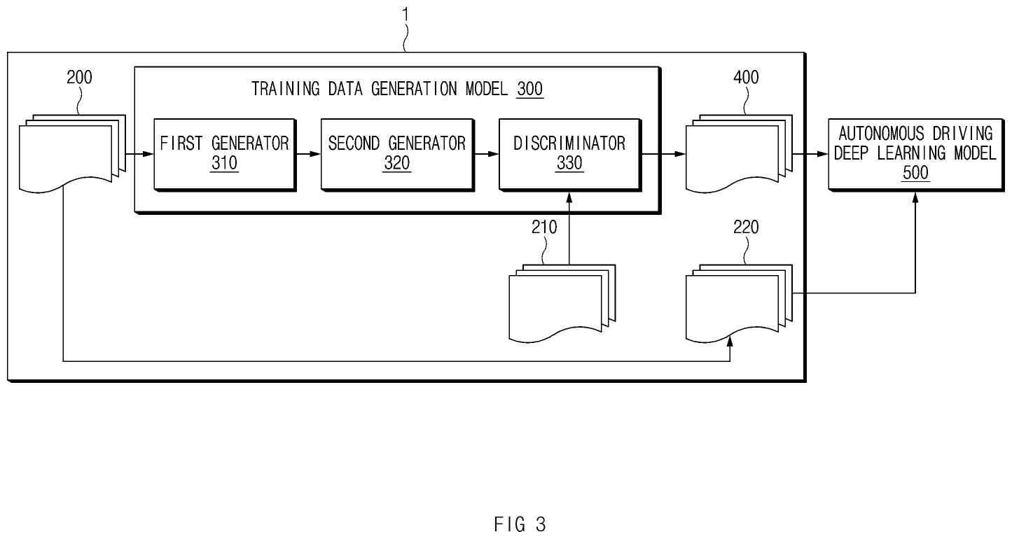

FIG. 3 is a drawing illustrating a detailed block diagram of a training data generation model according to an exemplary embodiment of the present disclosure.

Referring to FIG. 3, a training data generation model 300 may include a first generator 310 for degrading strength of a daytime road image 200 and a second generator 320 for reflecting a night feature in the daytime road image 200. Furthermore, the training data generation model 300 may include a discriminator 330 for discriminating truth of a night composite image 325 generated from the first generator 310 and the second generator 320.

In other words, an apparatus 1 for generating training data may include the training data generation model 300. The training data generation model 300 may include the plurality of generators 310 and 320. The first generator 310 and the second generator 320, that is, the two generators 310 and 320 are exemplified in FIG. 3. However, when a generator includes a structure configured for sharing generation capability of a single generator, there is no limit to the number of generators.

The apparatus 1 for generating the training data according to various exemplary embodiments of the present disclosure may include the two generators 310 and 320 to share work of the single generator between the two generators 310 and 320. Thus, a work ability of the single generator may be shared between the two generators 310 and 320.

In other words, because the work of generating the training data 400, which should be performed by the single generator in an existing technology, is divided and performed by the two generators 310 and 320 with different roles, a work processing ability may be improved.

In detail, one generator degrades strength of an input value and reflects a night feature in the existing technology. However, in an exemplary embodiment of the present disclosure, as the first generator 310 degrades strength of an input value and the second generator 320 reflects a night feature of the input value, work efficiency may be increased.

As described above, the training data generation model 300 included in the apparatus 1 for generating the training data may include a generative adversarial network (GAN) algorithm.

The GAN algorithm may refer to a generation model using an artificial neural network and may refer to a model for generating a fake data with a feature similar to real data using such a generation model.

Furthermore, the GAN algorithm may allow the generators 310 and 320 and the discriminator 330 to compete with each other in an adversarial manner to develop the generators 310 and 320 and the discriminator 330. In an exemplary embodiment of the present disclosure, the generators 310 and 320 for generating a night composite image 325 and the discriminator 330 for discriminating whether the night composite image 325 is fake may achieve an adversarial competition relationship. Herein, the generators 310 and 320 may be configured to generate fake data to generate fake data similar to real data and deceive the discriminator 330, and the discriminator 330 may discriminate the real data from the fake data. While the generators 310 and 320 and the discriminator 330 are trained, the generators 310 and 320 for generating the fake data incapable of being discriminated from the real data may be obtained.

In other words, the apparatus 1 for generating the training data according to various exemplary embodiments of the present disclosure may be configured to generate the night composite image 325 by the two generators 310 and 320 and may discriminate whether the night composite image 325 is real data or fake data by the discriminator 330.

At the present time, when the night composite image 325 is discriminated as the fake data, the generators 310 and 320 may correct a parameter so that the night composite image 325 is discriminated as the real data by the discriminator 330, to generate the night composite image 325.

The night composite image 325 generated by the apparatus 1 for generating the training data according to various exemplary embodiments of the present disclosure may include an image outside the vehicle, which is captured in a time zone when a certain time zone elapses out of the day, and an image outside the vehicle, which is captured after sunset. The night composite image 325 may include an image obtained by randomly generating a night road image captured in a low-illumination night environment, which contrasts with the daytime road image 200.

The discriminator 330 may compare the night composite image 325 generated by the two generators 310 and 320 with a night reference image 210 which is a real night road image to determine an error between the night composite image 325 and night reference image 210 and may discriminate the night composite image 325 as being fake based on that the determined error is greater than a predetermined reference value. On the other hand, the discriminator 330 may be configured to determine the night composite image 325 as training data 400 based on that the determined error is less than or equal to the predetermined reference value and may use the training data 400 as train data of an autonomous driving deep learning model 500.

A Pix2Pix algorithm may be used as the GAN algorithm used by the apparatus 1 for generating the training data according to an exemplary embodiment of the present disclosure. However, the GAN algorithm may be configured to process and learn an image like a cycle-GAN, it may be included in the training data generation model 300 without limit.

Because the daytime road image 200 and label data 220 for an artificial intelligence model (or object recognition, segmentation, depth recognition, or the like) of the daytime road image 200 is included the training data 400 in the daytime environment, which is previously obtained by the apparatus 1 for generating the training data according to an exemplary embodiment of the present disclosure, the label data 220 used for the daytime road image 200 may be applied to the night composite image 325 generated by the training data generation model 300 without change.

This is because original information of the daytime road image 200 is maintained without change in a process of generating the night composite image 325, but only an environment of the image is converted from a daytime environment to a night environment. As a result, the apparatus 1 for generating the training data according to various exemplary embodiments of the present disclosure may construct the training data 400 including the night road image and the label data 220 of the night road image and may use the training data 400 to train a network, thus shortening the process of constructing the night road image 400.

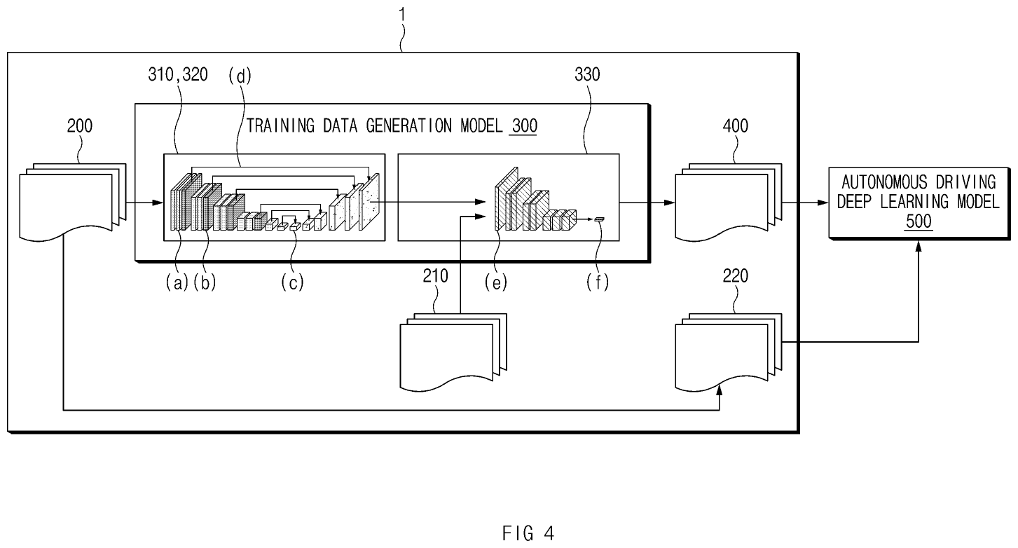

FIG. 4 is a drawing illustrating a detailed structure of a generator and a discriminator in a training data generation model according to an exemplary embodiment of the present disclosure.

Referring to FIG. 4, two generators 310 and 320 may include a U-NET model which is an image segmentation algorithm.

The U-NET model may be an encoder-decoder based model. In general, an encoder-decoder model may increase the number of channels and may decrease a dimension to capture a feature of an input image in an encoding step and may decrease the number of channels and may increase a dimension using only information encoded into a low dimension to recovery a high-dimensional image in a decoding step.

Herein, the U-NET model may extract a feature of an image using high-dimensional information as well as low-dimensional information and may simultaneously identify an accurate position for an image object. In detail, as shown in FIG. 4, the encoder of the U-NET model may pass an input image through a convolution block an including convolution and ReLU activation functions and may pass the input image through residual blocks b and c to extract a deep feature. Furthermore, the decoder of the U-NET model may reflect a feature of the encoder in the output feature of the encoder using a skip connection d. Thereafter, the output value of the U-Net model may be upsampled to output an image at the same resolution as the input image.

Next, a discriminator 330 of FIG. 4 may pass the input image through a leaky convolution block e including convolution and LeakyReLU activation functions to extract a feature and may finally pass the input image through a fully connected layer f to output a truth probability of the input image. At the instant time, the truth probability may be output as a value between “0” and “1”, which may refer to being discriminated as a fake image as it is close to “0” and being discriminated as a real image as it is close to “1”.

A training data generation model 300 according to various exemplary embodiments of the present disclosure may transmit training data 400 generated by the two generators 310 and 320 and the discriminator 330, which are described above, to an autonomous driving deep learning model 500 to use the training data 400 as train data. At the instant time, the training data generation model 300 may simplify a label process using the label data 220 of the daytime road image 200 without change.

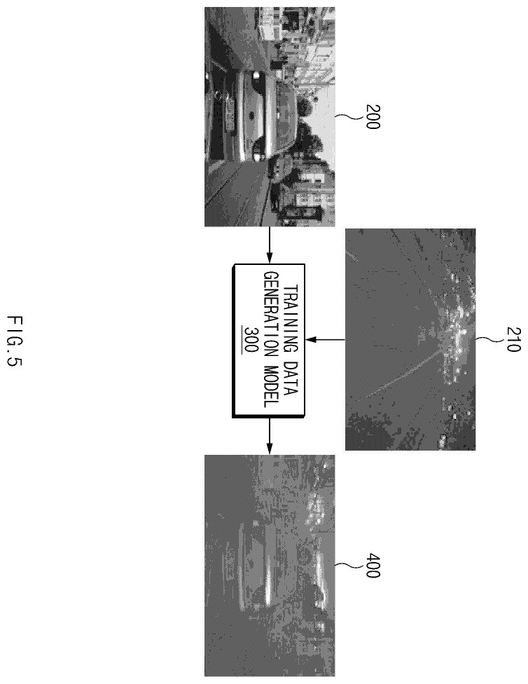

FIG. 5 is a drawing illustrating that a night road image is generated from a daytime road image by a training data generation model according to an exemplary embodiment of the present disclosure.

Referring to FIG. 5, an apparatus 1 for generating training data may receive a daytime road image 200 from an external device 2. Label data 220 may be included in the received daytime road image 200. The label data 220 may refer to data which is divided into separate objects, such as a vehicle, a line, a building, and a pedestrian, in which different labels are assigned to the separate objects.

A memory 110 of the apparatus 1 for generating the training data may store an actually captured night road image. A training data generation model 300 may use the real night road image stored in the memory 110 as a night reference image 210 used for a discriminator 330 to determine whether the image is true. At the instant time, the night reference image 210 may include a night feature. The night feature may include a vehicle image, a line image, a building image, and a pedestrian image in a low-illumination environment.

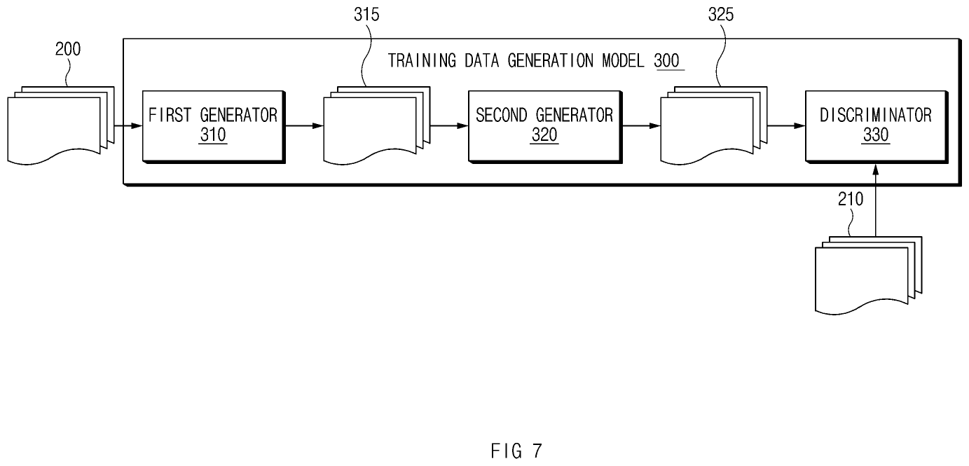

Thus, two generators 310 and 320 of the training data generation model 300 may degrade strength of the daytime road image 200 and may reflect the above-mentioned night feature to generate a night composite image 325. The discriminator 330 may compare the night composite image 325 with the night reference image 210 and may be configured to determine the night composite image 325 as training data 400, when an error between the night composite image 325 with the night reference image 210 is less than or equal to a predetermined reference value. At the instant time, there may be various modification examples in an order in which an input value is input to the two generators 310 and 320. This will be described below with reference to FIG. 7.

The process of generating the night composite image 325 in the apparatus 1 for generating the training data according to an exemplary embodiment of the present disclosure is represented as Equations 1 to 4 below.

$$( {I}_{D} \times α ) + {F}_{N} = {I}_{N} \qquad [ Equation 1 ]$$

$$α = {G}_{α} ( {I}_{D} ) \qquad [ Equation 2 ]$$

$${F}_{N} = {I}_{N} - ( {I}_{D} \times α ) \qquad [ Equation 3 ]$$

$${F}_{N} = {G}_{N} ( {I}_{D} \times α ) \qquad [ Equation 4 ]$$

In detail, I_{D} of Equation 1 above may refer to the daytime image, I_{N} may refer to the night image, and a may refer to the strength degradation parameter determined as in Equation 2 above. G_{α} of Equation 2 above may be the alpha generator, which may refer to the first generator 310. F_{N} of Equation 3 above may refer to the night feature. G_{N} of Equation 4 above may be the night feature generator, which may refer to the second generator 320. In other words, the image in which the night feature is reflected and the residual of the strength degradation image may be learned based on the above equations.

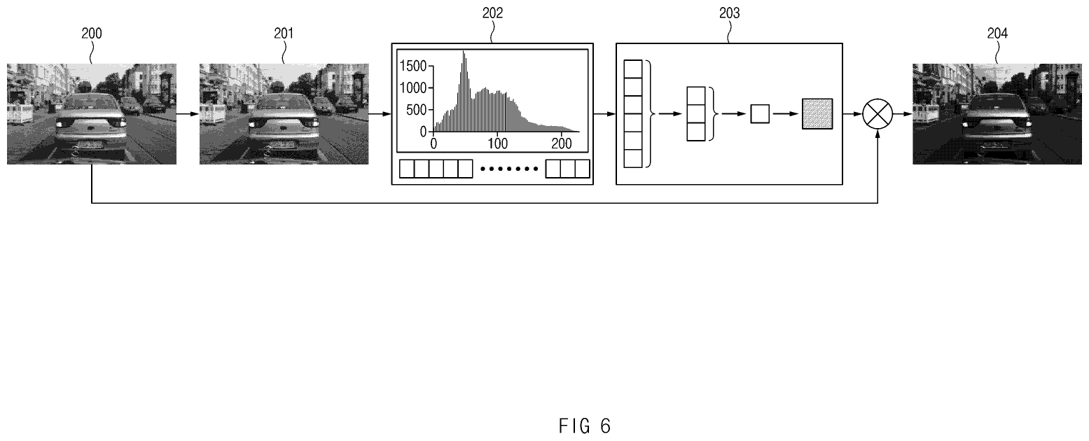

FIG. 6 is a drawing illustrating that a generator of an apparatus for generating training data degrades strength of a daytime road image according to an exemplary embodiment of the present disclosure.

Referring to FIG. 6, a first generator 310 of an apparatus 1 for generating training data according to various exemplary embodiments of the present disclosure may change a daytime road image 200 to a grayscale image 201 to degrade strength of the daytime road image 200. A grayscale may refer to a grayscale of a single channel, which includes a different color and different contrast.

Thereafter, the first generator 310 may extract a histogram vector 202 from the grayscale image 201 and may input the extracted histogram vector 202 to a multi layer perceptron (MLP) structure 203 to extract a strength degradation parameter of a 1×1 magnitude. At the instant time, the last layer of the MLP structure 203 may be extracted as a sigmoid function to include a value between “0” and “1”.

Thereafter, the processor 100 may multiply the daytime road image 200 by the strength degradation parameter to degrade strength of the entire image, thus generating a strength degradation image 204.

FIG. 7 is a drawing illustrating an example of an order in which a generator and a discriminator are arranged in a training data generation model according to an exemplary embodiment of the present disclosure.

Referring to FIG. 7, as described above, a training data generation model 300 may include a first generator 310 for degrading strength of a daytime road image 200 and a second generator 320 for reflecting a night feature in the daytime road image 200. Furthermore, the training data generation model 300 may include a discriminator 330 for discriminating truth of a night composite image 325 generated from the first generator 310 and a second generator 320. FIG. 7 illustrates an exemplary embodiment of inputting an output result of the first generator 310 as an input value of the second generator 320.

In detail, an apparatus 1 for generating training data may receive the daytime road image 200 from the outside. The daytime road image 200 may be input as an input value of the first generator 310. Thereafter, the first generator 310 may degrade strength of the received daytime road image 200 to generate a strength degradation image 315 and may input the strength degradation image 315 as an input value to the second generator 320.

Thereafter, the second generator 320 may reflect a night feature in the input strength degradation image 315 to generate a night composite image 325. A processor 100 may input the generated night composite image 325 as an input value to the discriminator 330. The discriminator 330 may be configured to determine an error between the input night composite image 325 and a night reference image 210 and may be configured to determine the night composite image 325 as training data 400, when the determined error is less than or equal to a predetermined value.

Furthermore, when the determined error is greater than the predetermined value, the first generator 310 and the second generator 320 may adjust a variable to reduce the error, thus generating the night composite image 325. Thus, the apparatus 1 for generating the training data according to various exemplary embodiments of the present disclosure may be configured to generate the night composite image 325 based on the daytime road image 200 and may use the night composite image 325 as the training data 400 of an autonomous driving deep learning model 500, when the night composite image 325 is greater than a predetermined criterion.

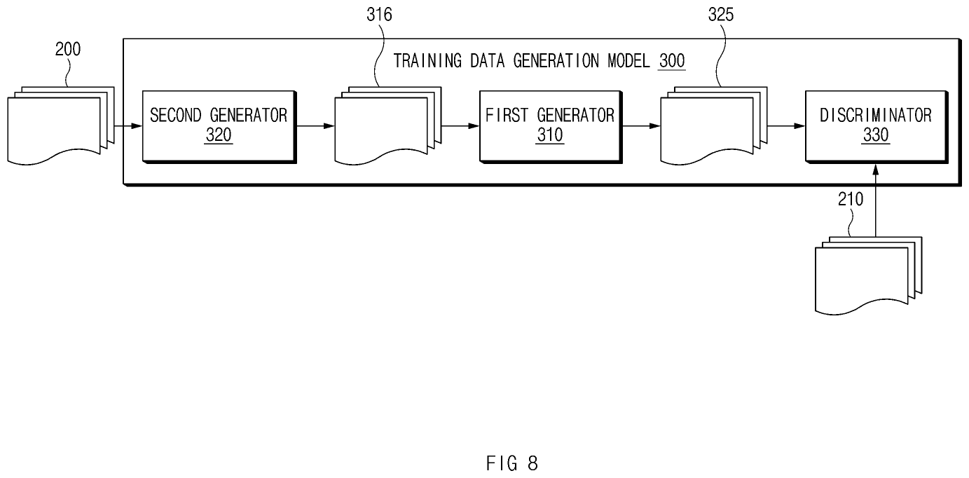

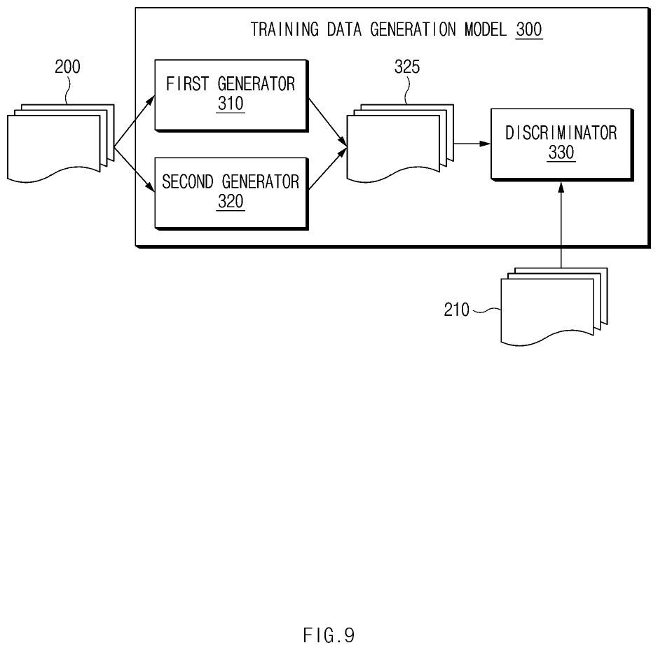

The arrangement of the first generator 310 and the second generator 320 may be changed as shown in FIG. 7, FIG. 8 and FIG. 9 based on a hyper-parameter of the training data generation model 300 and an experimental result value of a loss function.

The loss function in an exemplary embodiment of the present disclosure is defined as Equations 5 and 6 below.

$${L}_{G} = ( {E}_{X} [ {( D ( {G}_{N} ( {G}_{α} ( X ) ) ) - 1 )}^{2} ] ) \qquad [ Equation 5 ]$$

$${L}_{D} = {E}_{Y} [ {( D ( Y ) - 1 )}^{2} ] + {E}_{X} [ ( {D ( {G}_{N} ( {G}_{α} ( X ) ) )}^{2} ] \qquad [ Equation 6 ]$$

Herein, X may refer to the simulation data, Y may refer to the real-world data, G_{α} may refer to the first generator 310, G_{N} may refer to the second generator 320, D may refer to the discriminator 330, and E may refer to the predicted value. In other words, the training data generation model 300 may learn a parameter in the direction of reducing the loss function of FIG. 5 and FIG. 6.

FIG. 8 is a drawing illustrating another example of an order in which a generator and a discriminator are arranged in a training data generation model according to an exemplary embodiment of the present disclosure.

FIG. 8 illustrates an exemplary embodiment of inputting an output result of a second generator 320 as an input value of a first generator 310.

In detail, an apparatus 1 for generating training data may receive a daytime road image 200 from the outside. The daytime road image 200 may be input as an input value of the second generator 320. Thereafter, the second generator 320 may reflect a night feature in the received daytime road image 200 to generate a night feature reflection image 316 and may input the night feature reflection image 316 as an input value to the first generator 310.

Thereafter, the first generator 310 may degrade strength of the input night feature reflection image 316 to generate a night composite image 325. A processor 100 may input the generated night composite image 325 as an input value to a discriminator 330. The discriminator 330 may be configured to determine an error between the input night composite image 325 and a night reference image 210 and may be configured to determine the night composite image 325 as training data 400, when the determined error is less than or equal to a predetermined value.

Furthermore, when the determined error is greater than the predetermined value, the first generator 310 and the second generator 320 may adjust a variable to reduce the error, thus generating the night composite image 325.

Thus, the apparatus 1 for generating the training data according to various exemplary embodiments of the present disclosure may be configured to generate the night composite image 325 based on the daytime road image 200 and may use the night composite image 325 as the training data 400 of an autonomous driving deep learning model 500, when the night composite image 325 is greater than a predetermined criterion.

FIG. 9 is a drawing illustrating another example of an order in which a generator and a discriminator are arranged in a training data generation model according to an exemplary embodiment of the present disclosure.

FIG. 9 illustrates an exemplary embodiment in which a processor 100 inputs a daytime road image 200 to a first generator 310 and a second generator 320 at the same time.

In detail, an apparatus 1 for generating training data may receive a daytime road image 200 from the outside. The daytime road image 200 may be input as an input value of the first generator 310 and the second generator 320. Thereafter, the first generator 310 may degrade strength of the received daytime road image 200 to generate a strength degradation image, and the second generator 320 may reflect a night feature in the received daytime road image 200 to generate a night feature reflection image.

Thereafter, a processor 100 may combine the strength degradation image generated by the first generator 310 with the night feature reflection image generated by the second generator 320 to generate a night composite image 325. The processor 100 may input the generated night composite image 325 as an input value to a discriminator 330. The discriminator 330 may be configured to determine an error between the input night composite image 325 and a night reference image 210 and may be configured to determine the night composite image 325 as training data 400, when the determined error is less than or equal to a predetermined value.

Furthermore, when the determined error is greater than the predetermined value, the first generator 310 and the second generator 320 may adjust a variable to reduce the error, thus generating the night composite image 325. Thus, the apparatus 1 for generating the training data according to various exemplary embodiments of the present disclosure may be configured to generate the night composite image 325 based on the daytime road image 200 and may use the night composite image 325 as the training data 400 of an autonomous driving deep learning model 500, when the night composite image 325 is greater than a predetermined criterion.

Furthermore, additional generators may be provided in addition to the first generator 310 and the second generator 320. A portion of work performed by the first generator 310 and the second generator 320 may be shared between the additional generators, thus optimizing the efficiency of a training data generation model 300.

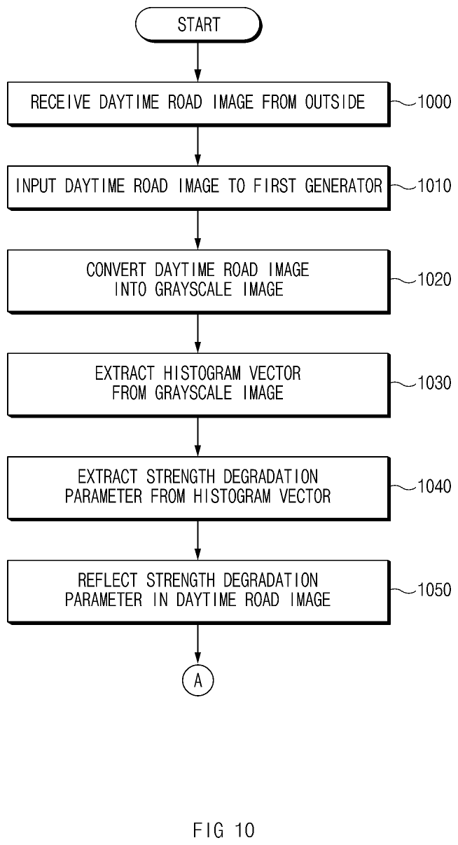

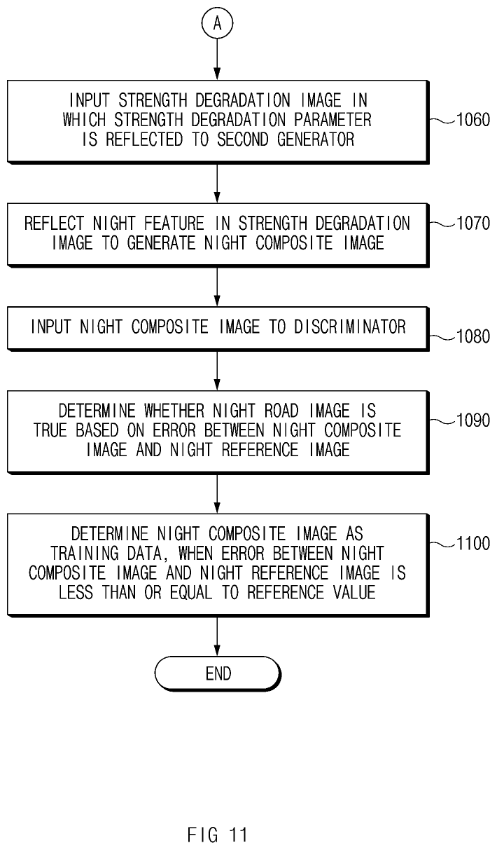

FIG. 10 is a drawing illustrating a control flowchart of a method for generating training data according to an exemplary embodiment of the present disclosure. FIG. 11 is a drawing illustrating a control flowchart of a method for generating training data, which is subsequent to FIG. 10, according to an exemplary embodiment of the present disclosure.

Referring to FIG. 10, in operation 1000, an apparatus 1 for generating training data according to various exemplary embodiments of the present disclosure may receive a daytime road image 200 from the outside. Thereafter, in operation 1010, a processor 100 may input the daytime road image 200 to a first generator 310. In operation 1020, the first generator 310 may convert the daytime road image 200 into a grayscale image which is a grayscale image of a single channel, which includes a different color and different contrast.

In operation 1030, the first generator 310 may extract a histogram vector indicating a brightness distribution of the grayscale image from the converted grayscale image. In operation 1040, the first generator 310 may extract a strength degradation parameter from the histogram vector.

Thereafter, in operation 1050, the first generator 310 may reflect the strength degradation parameter in the received daytime road image 200. In detail, the first generator 310 may multiply the daytime road image 200 by the strength degradation parameter to degrade strength of the entire image.

Thereafter, in operation 1060, the processor 100 may input a strength degradation image in which the strength degradation parameter is reflected to a second generator 320. In operation 1070, the processor 100 may be configured to generate a night composite image 325 by reflecting a night feature including a vehicle image, a line image, a building image, and a pedestrian image in a low-illumination environment in the strength degradation image.

In operation 1080, the processor 100 may input the generated night composite image 325 to a discriminator 330. In operation 1090, the processor 100 may learn a difference between the night composite image 325 and a night reference image 210 and may be configured to determine whether a night road image is true.

Thereafter, when an error between the night composite image 325 and the night reference image 210 is less than or equal to a reference value, in operation 1100, the discriminator 330 may be configured to determine the night composite image 325 as training data 400. When the error is greater than the reference value, the discriminator 330 may correct a parameter in the direction of reducing the error to generate the night composite image 325.

The processor 100 may be configured to generate the training data 400 about the night road image based on a series of procedures described above. As described above, an order in which the first generator 310 and the second generator 320 are arranged may be changed based on a hyper-parameter and a result value of a loss function.

As a result, the apparatus 1 for generating the training data according to various exemplary embodiments of the present disclosure may be configured to generate the night composite image 325 based on a GAN using a histogram vector and may convert the daytime road image 200 including label data 220 into the night composite image 325 in which a characteristic of a night road environment is reflected. Thus, the apparatus 1 for generating the training data according to various exemplary embodiments of the present disclosure may obtain the training data 400 without collecting and labeling a real night road image, thus, reducing a time and effort for constructing the training data 400 of the night road image.

Meanwhile, the disclosed exemplary embodiments of the present disclosure may be implemented in a form of a storage medium which stores instructions executable by a computer. The instructions may be stored in a form of a program code and may be configured to generate a program module and perform operations of the disclosed exemplary embodiments of the present disclosure, when executed by the processor 100. The storage medium may be implemented as a computer-readable storage medium.

The computer-readable storage media may include all types of storage media which store instructions decoded by the computer. For example, the computer-readable storage media may be a read only memory (ROM), a random access memory (RAM), a magnetic tape, a magnetic disc, a flash memory 110, an optical data storage device, and the like.

Furthermore, the computer-readable storage medium may be provided in a form of a non-transitory storage medium. Herein, the term “non-transitory storage medium” simply means that the storage medium is a tangible device and does not include a signal (e.g., an electromagnetic wave), but the present term does not differentiate between when data is semipermanently stored in the storage medium and when data is temporarily stored in the storage medium. For example, the “non-transitory storage medium” may include a buffer in which data is temporarily stored.

According to an exemplary embodiment of the present disclosure, a method according to various embodiments included in the present disclosure may be included and provided in a computer program product. The computer program product may be traded as a product between a seller and a buyer. The computer program product may be distributed in a form of a machine-readable storage medium (e.g., compact disc read only memory (CD-ROM)), or be distributed (e.g., downloaded or uploaded) online via an application store (e.g., PlayStore™), or between two user devices (e.g., smartphones) directly. If distributed online, at least a part of the computer program product may be temporarily generated or at least temporarily stored in the machine-readable storage medium, such as a memory 110 of the manufacturer's server, a server of the application store, or a relay server.

According to an exemplary embodiment of the present disclosure, the apparatus for generating the training data may be configured to generate a composite data by reflecting a feature of a night road image using training of a generative adversarial network (GAN) using a histogram vector in a daytime road dataset including a label, thus reducing a time and cost required to construct a training dataset in a night environment.

According to an exemplary embodiment of the present disclosure, the apparatus for generating the training data may use a label of a daytime road image without change to omit work for generating a label for each artificial intelligence model, which takes a lot of time and money, thus increasing efficiency.

According to an exemplary embodiment of the present disclosure, the apparatus for generating the training data may improve an ability to generate an image in a GAN algorithm using a 2-stage based generator.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for generating training data, the apparatus comprising:
a communication device configured to receive a daytime road image;
a memory storing a training data generation model for generating a night composite image from the daytime road image; and
a processor operatively connected to the communication device and the memory and configured to degrade strength of the daytime road image based on that the daytime road image is input as an input value to the training data generation model and to reflect a night feature to generate the night composite image.

2. The apparatus of claim 1, wherein the training data generation model includes:
a generator configured to degrade the strength of the daytime road image and reflect the night feature to generate the night composite image; and
a discriminator configured to learn a difference between the night composite image and a night reference image to discriminate the night composite image.

3. The apparatus of claim 2, wherein the generator includes:
a first generator configured to degrade the strength of the daytime road image; and
a second generator configured to reflect the night feature in the daytime road image.

4. The apparatus of claim 3, wherein the first generator is further configured to convert the daytime road image into a grayscale image and extract a histogram vector from the grayscale image, to extract a strength degradation parameter from the histogram vector, and to reflect the strength degradation parameter in the daytime road image to degrade the strength of the daytime road image.

5. The apparatus of claim 3, wherein the processor is further configured to input the daytime road image to the first generator to degrade the strength and to input the daytime road image, the strength of which is degraded, to the second generator to generate the night composite image.

6. The apparatus of claim 3, wherein the processor is further configured to input the daytime road image to the second generator to reflect the night feature and to input the daytime road image in which the night feature is reflected to the first generator to generate the night composite image.

7. The apparatus of claim 3, wherein the processor is further configured to input the daytime road image to the first generator and the second generator at a same time to generate the night composite image.

8. The apparatus of claim 2, wherein the processor is further configured to transform the daytime road image so that the generator reduces an error between the night composite image and the night reference image, to generate the night composite image, upon concluding that the error is greater than a predetermined reference value.

9. The apparatus of claim 2, wherein the processor is further configured to determine the night composite image as the training data, upon concluding that an error between the night composite image and the night reference image is less than or equal to a predetermined reference value.

10. The apparatus of claim 9, wherein the processor is further configured to reflect label information included in the daytime road image in the night composite image to generate the training data.

11. A method for generating training data, the method comprising:
receiving a daytime road image;
degrading, by a processor, strength of the daytime road image, based on that the daytime road image is input as an input value to a training data generation model for generating the daytime road image as a night composite image; and
reflecting, by the processor, a night feature to generate the night composite image.

12. The method of claim 11, wherein the training data generation model includes:
a generator configured to degrade the strength of the daytime road image and reflect the night feature to generate the night composite image; and
a discriminator configured to learn a difference between the night composite image and a night reference image to discriminate the night composite image.

13. The method of claim 12, wherein the generator includes:
a first generator configured to degrade the strength of the daytime road image; and
a second generator configured to reflect the night feature in the daytime road image.

14. The method of claim 11, wherein the degrading of the strength of the daytime road image includes:
converting the daytime road image into a grayscale image;
extracting a histogram vector from the grayscale image;
extracting a strength degradation parameter from the histogram vector; and
reflecting the strength degradation parameter in the daytime road image to degrade the strength of the daytime road image.

15. The method of claim 13, further including:
inputting, by the processor, the daytime road image to the first generator to degrade the strength and inputting, by the processor, the daytime road image, the strength of which is degraded, to the second generator to generate the night composite image.

16. The method of claim 13, further including:
inputting, by the processor, the daytime road image to the second generator to reflect the night feature and inputting, by the processor, the daytime road image in which the night feature is reflected to the first generator to generate the night composite image.

17. The method of claim 13, further including:
inputting, by the processor, the daytime road image to the first generator and the second generator at a same time to generate the night composite image.

18. The method of claim 12, further including:
transforming, by the processor, the daytime road image so that the generator reduces an error between the night composite image and the night reference image, to generate the night composite image, upon concluding that the error is greater than a predetermined reference value.

19. The method of claim 12, further including:
determining, by the processor, the night composite image as the training data, upon concluding that an error between the night composite image and the night reference image is less than or equal to a predetermined reference value.

20. The method of claim 19, wherein the determining of the training data includes:
reflecting label information included in the daytime road image in the night composite image to generate the training data.
